(19) United States
(12) Patent Application Publication
(10) Pub. No.: US 2024/0378752 A1
(43) Pub. Date: Nov. 14, 2024

(54) LATENT SPACE NEURAL ENCODING FOR HOLOGRAPHIC COMMUNICATION

(71) Applicant: IKIN, Inc., Dripping Springs, TX (US)

(72) Inventors: Bryan Lloyd WESTCOTT, Austin, TX (US); Christopher Henry VELA, Austin, TX (US); James Charles STIEFELMAIER, Austin, TX (US); Kristy TIPTON, Austin, TX (US)

(21) Appl. No.: 18/653,552

(22) Filed: May 2, 2024

Related U.S. Application Data
(60) Provisional application No. 63/500,837, filed on May 8, 2023.

(51) Int. Cl. G06T 7/80; G06T 7/70

(52) U.S. Cl. CPC G06T 7/80; G06T 7/70; G06T 2207/20081; G06T 2207/20084

(57) ABSTRACT

A system and method generates 3D-aware reconstructions of a static or dynamic scene by using a neural network to encode captured images of the scene into a compact latent space scene model. The method includes receiving image frames of a scene where each image frame is associated with camera extrinsics including a three-dimensional (3D) camera location and a camera direction. A neural network is trained using the image frames (e.g., video frames) and the camera extrinsics to encode the frames as models of the scene in a latent space associated with a latent model decoder. The method further includes transmitting one or more of the models of the scene to a viewing device including the latent model decoder. The latent model decoder is configured to decode the models to generate imagery corresponding to novel 3D views of the scene.

### CROSS-REFERENCE TO RELATED APPLICATION

This application claims priority to U.S. Provisional Patent Application 63/500,837, filed May 8, 2023, the contents of which are incorporated herein by reference.

### FIELD

The present disclosure generally relates to techniques for generating three-dimensional (3D) scene representations and, more particularly, to creating virtual views of 3D scenes originally captured using two-dimensional (2D) images.

### BACKGROUND

Dynamic scenes, such as live sports events or concerts, are often captured using multi-camera setups to provide viewers with a range of different perspectives. Traditionally, this has been achieved using fixed camera positions, which limits the viewer's experience to a predefined set of views. Generating photorealistic views of dynamic scenes from additional views (beyond the fixed camera views) is a highly challenging topic that is relevant to applications such as, for example, virtual and augmented reality. Traditional mesh-based representations are often incapable of realistically representing dynamically changing environments containing objects of varying opacity, differing specular surfaces, and otherwise evolving scene environments. However, recent advances in computational imaging and computer vision have led to the development of new techniques for generating virtual views of dynamic scenes.

One such technique is the use of neural radiance fields (NeRFs), which allows for the generation of high-quality photorealistic images from novel viewpoints. NeRFs are based on a neural network that takes as input a 3D point in space and a camera viewing direction and outputs the radiance, or brightness, of that point. This allows for the generation of images from any viewpoint by computing the radiance at each pixel in the image. NeRF enables highly accurate reconstructions of complex scenes. Despite being of relatively compact size, the resulting NeRF models of scene allow for fine-grained resolution to be achieved during the scene rendering process.

FIG. 1A illustrates a conventional process 10 for training a NeRF-based system to generate reconstructed views of a scene using captured images of the scene. As shown, training images 14 of the scene are provided along with associated camera extrinsics 18 (i.e., a camera location in the form of voxel coordinates (x,y,z) and a camera pose in the form of an azimuth and elevation) as input to a neural network 20 implementing a NeRF. The neural network 20 is trained to define a color (R,G,B) and opacity (alpha) specific to each 3D scene coordinate and viewing direction. During the training process a volume renderer 28 uses the neural network 20 for inference many times per pixel create to generated RGB(D) imagery 32 corresponding to the scene. The supervision label used during training of the NeRF is the associated collected imagery 32, which is compared 40 to the training imagery 14. The weights of the neural network 20 are then adjusted 44 based upon this comparison.

Referring to FIG. 1B, once training has been completed the NeRF modeled by neural network 20 may be queried using novel camera view(s) 19 specifying one or more viewing positions and directions corresponding to one or more virtual cameras. In response, the volume renderer 28 generates RGB(D) imagery corresponding to view(s) of the scene from the viewing position(s) and direction(s) specified by the novel camera view(s) 19. Depth may optionally be computed using various volume rendering techniques such as the “marching cubes” method. See, e.g., https://dl.acm.org/doi/abs/10.1145/37402.37422.

Unfortunately, NeRFs are computationally expensive due to the large amount of data required to store radiance information for a high-resolution 3D space. For instance, storing radiance information at 1-millimeter resolution for a 10-meter room would require a massive amount of data given that there are 10 billion cubic millimeters in a 10-meter room. Additionally, and as noted above, NeRF systems must use a volume renderer to generate views, which involves tracing rays through the cubes for each pixel. Again, considering the example of the 10-meter room, this would require approximately 82 billion calls to the neural net to achieve 4k image resolution.

In view of the substantial computational and memory resources required to implement NeRF, NeRF has not been used to reconstruct dynamic scenes. This is at least partly because the NeRF model would need to be trained on each frame representing the scene, which would require prodigious amounts of memory and computing resources even in the case of dynamic scenes of short duration. Additionally, changes in external illumination (lighting) could significantly alter the NeRF model, even if the structure of the scene does not change, requiring a large amount of computation and additional storage. As a consequence, NeRF and other novel view scene encoding algorithms have been limited to modeling static objects and environments.

### SUMMARY

Disclosed herein is a system and method for generating 3D-aware reconstructions of a static or dynamic scene by using a neural network to encode captured images of the scene into a compact latent space scene model. The method includes receiving one or more image frames of a scene where each of the one or more image frames is associated with camera extrinsics including a three-dimensional (3D) camera location and a camera direction. A neural network is trained using the one or more image frames (e.g., video frames) and the camera extrinsics to encode the frames as a plurality of models of the scene in a latent space associated with a latent model decoder. The method further includes transmitting one or more of the plurality of models of the scene to a viewing device including the latent model decoder. The latent model decoder is configured to decode the one or more of the plurality of models to generate imagery corresponding to novel 3D views of the scene. That is, novel views of the static or dynamic scene may be reconstructed from a desired 3D viewing location and perspective and at a desired time instant, irrespective of whether the camera(s) originally recording the scene were located at the desired 3D viewing location.

In another aspect, the disclosure is directed to a latent space direct novel view synthesis coder-decoder, or “latent NVS codec”, operative to generate models of a scene encoded into a latent space and reconstruct 3D aware representations of the scene. The encoded models are transmitted between users over bandwidth-limited, high-latency, or unreliable links. Upon receipt, the encoded models may be decoded to directly provide novel views of the scene from a novel virtual camera pose and location in 3D space. The latent NVS codec may incorporate various features, either alone or in combination, to optimize the compression and transmission. These features of the latent NVS codec are summarized below.

The latent NVS codec may capture the scene in a latent model encoded space, resulting in a much smaller model size compared to traditional methods. This allows for efficient storage and transmission of volumetric video data while maintaining photorealism, including depth information, and leveraging experience for improved learning.

The latent NVS codec adopts a camera-centric rendering approach, avoiding expensive volume rendering and directly displaying desired novel views. This allows for real-time rendering of holographic video from arbitrary viewpoints, enhancing the immersive experience for viewers.

The latent NVS codec separates the extrinsic lighting from intrinsic material properties, allowing for relighting of models and more realistic scene composites. This is closer to the paradigm of current CGI and video games, enabling greater customization and visual fidelity.

The latent NVS codec may be formulated to include a joint auto-encoder, enabling fast video applications and temporal processing. This allows for efficient compression and decompression of volumetric video data, enabling real-time transmission and rendering of holographic video with high visual quality.

The latent NVS codec may separate live/moving subjects from static objects, leveraging classification methods. The environment model may be transmitted separately from the moving subjects, and individual non-background subjects may be compressed separately.

Time-synchronized conventional and/or holographic audio may be included in the latent NVS codec. Audio changes, similar to video, may be represented implicitly with an AI structure, and the equivalent to a single frame of video may optionally be a spectrogram.

A differential temporal definition may be employed to avoid transmitting redundant information. Latent model representations may be defined relative to previous frames and may reference future frames. This differential definition may be built into the neural network architecture.

The latent NVS codec may be configured to learn from experience using latent codes and embedding layers. Embedding layers trained from a larger population can be used to represent subjects' body geometry, and differences of the desired subject can be broadcasted. Additionally, embedding layers may represent deformations of the desired subject, such as body pose changes.

Spotlight training may be utilized to improve perceptual quality with datalink latency for live communication. By focusing training on the areas where viewers are looking in the holographic space, rendering on the client side can look good in those areas and allow for novel view synthesis. Future spotlight locations may be predicted based on motion estimates of the subject and/or viewer, optionally incorporating accelerometer information.

Higher-quality processing may be applied to human features such as face, hands, and body pose, and can be sent at higher bandwidth. Human segmentation may be represented with other generative human avatar models.

In one implementation the latent representation could be decoded to an intermediate textured CGI format (e.g., textured mesh) that a conventional renderer (e.g., Unity or Unreal) could convert to an RGB(D) image viewable on a conventional or volumetric display. In this variation, part of the decoding procedure would involve a conventional CGI renderer (e.g., Unity, Unreal, etc.). Instead of a single decoder that converts from latent space directly to images, it would first decode to an intermediate CGI model (e.g., FBX format) which would include both the explicit model (e.g., a textured mesh) and explicit illumination (e.g., CGI Lights). In this implementation the illumination encoded intrinsics could include, for example, albedo, opacity, glossiness, transmissiveness, alpha map, and any other relevant data. The conventional GCI renderer can be optimized for the receiving device and may optionally be a commercial-off-the-shelf solution. By including both parts (the latent-to-CGI representation and the CGI renderer), it is possible to train this network in an unsupervised manner since the expectation is that the training will still cause the final rendered output to be as close as possible to the original input. In this case the fidelity could include geometric accuracy and/or other perceptual metrics. Of course, it will be appreciated that in other implementations supervised training could still be utilized.

In another variation the input images could further be generated from a CGI Model. Training could be performed in this case either by comparing the CGI-rendered imagery or the original models or both.

In summary, disclosed herein is a novel method for real-time volumetric or holographic communication using latent novel view synthesis (NVS) devices. The method preferably involves the exchange of prior information between all parties, which could include biometrics, known background, and other customizable information at both ends. The encoding is flexible and can be customized or adapted on the fly to support biometrics, separation of lighting, stylization, and static background. The depth supervision/regularization minimizes the cameras for parallax, while obviating the need for separate rendering that would be required for CGI or NeRF.

In one aspect the disclosed method accomplishes the separation of lighting from the intrinsic properties of the surface/scene-component by implicitly learning albedo, opacity, glossiness, transmissiveness, alpha map, and any other relevant data, making it possible to render any XR/volumetric/holographic view at the receiver. The computation of one or more additional surface intrinsic properties (albedo, opacity, glossiness, transmissiveness, alpha map) beyond the properties commonly computed in conventional NeRF (i.e., transparency/alpha) provides at least two principal benefits. First, computation of one or more of the additional surface intrinsic properties allows the encoder (which produces a view for display on a volumetric device) to more efficiently (in terms of model size) and more effectively (in terms of perceptual quality) separate out the lighting intrinsics from the extrinsics, thus providing better compression, shorter real-time training processing time and better perceptual quality. Second, this computation allows for more efficient and more effective export to an alternative (possibly intermediate) GCI format (e.g., a textured mesh such as the FBX format) for rendering with a conventional CGI renderer.

A joint encoder approach described herein may be utilized rather than supervised learning. Biometric encodings learned for identity verification include more than facial structure and iris and can include hairstyle. Spotlight training enables focused training on specific known viewer directions, and NVS may be used to fill in the gaps until optimal new information can be received. The proposed method is highly effective and enables real-time communication with a high level of accuracy and customization.

It may thus be appreciated that the disclosed latent NVS codec incorporates various techniques and optimizations to compress and transmit real-time computer-generated holograms efficiently over bandwidth-limited, high-latency, or unreliable links. The disclosed latent NVS codec represents a significant advancement in the field of holographic video compression, providing a more efficient and realistic approach for enabling real-time holographic video. The unique features of the latent NVS codec, including latent model encoding, camera-centric rendering, intrinsic material separation, and joint auto-encoder formulation, provide substantial advantages over existing methods and open up new possibilities for holographic video applications.

### BRIEF DESCRIPTION OF THE FIGURES

The invention is more fully appreciated in connection with the following detailed description taken in conjunction with the accompanying drawings, in which:

FIG. 1A illustrates a conventional process for training a neural radiance field system to generate reconstructed views of a scene using captured images of the scene.

FIG. 1B illustrates querying a trained neural network 20 using novel camera views specifying one or more viewing positions and directions corresponding to one or more virtual cameras.

FIG. 2A illustrates a latent novel view synthesis (NVS) communication system in accordance with an embodiment of the invention.

FIG. 2B illustrates another latent novel view synthesis (NVS) communication system in accordance with an embodiment of the invention.

FIG. 3A illustrates a latent space novel view synthesis (NVS) process for training an exemplary latent model encoder to generate novel views of a scene using a supervised learning process in accordance with an embodiment of the invention.

FIG. 3B illustrates a process by which a latent model encoder is queried to render views of a scene in response to novel camera view(s) of the scene provided by a user of a latent NVS receiving device.

FIG. 4 illustrates an exemplary view warping process for improving depth accuracy.

FIG. 5A illustrates a latent space NVS process for training an exemplary latent model encoder to synthesize novel views of a scene using a supervised learning with additional parametrization in accordance with an embodiment of the invention.

FIG. 5B illustrates a process by which the latent model encoder is queried to render views of a scene in response to novel camera view(s) of the scene provided by a user of a latent NVS receiving device.

FIG. 6A illustrates a process for training a joint latent NVS autoencoder to generate novel views of a scene without supervision.

FIG. 6B illustrates a process by which a latent NVS decoder is queried to render views of a scene in response to novel camera view(s) of the scene provided by a user of a latent NVS receiving device.

FIG. 7 provides a conceptual representation of the operation of the joint latent NVS autoencoder of FIG. 6A.

FIG. 8 is a functional view of a differential transmission encoder designed to be included within a latent NVS sending device.

FIG. 9 is a block diagram representation of an electronic device configured to operate as a latent NVS sending and/or latent NVS receiving device in accordance with an embodiment of the invention.

FIG. 10 illustrates a process for training a CGI variant of an auto-encoder in accordance with an embodiment of the invention.

FIG. 11 is a block diagram illustrating a process for training an alternate CGI variant of an auto-encoder in accordance with an embodiment of the invention.

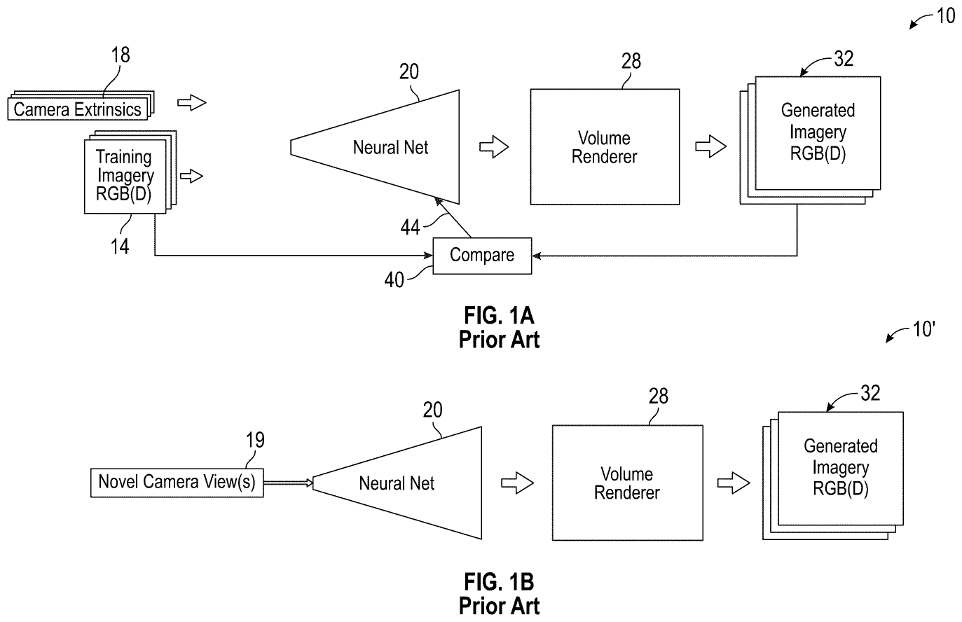

Like reference numerals refer to corresponding parts throughout the several views of the drawings.

### DETAILED DESCRIPTION

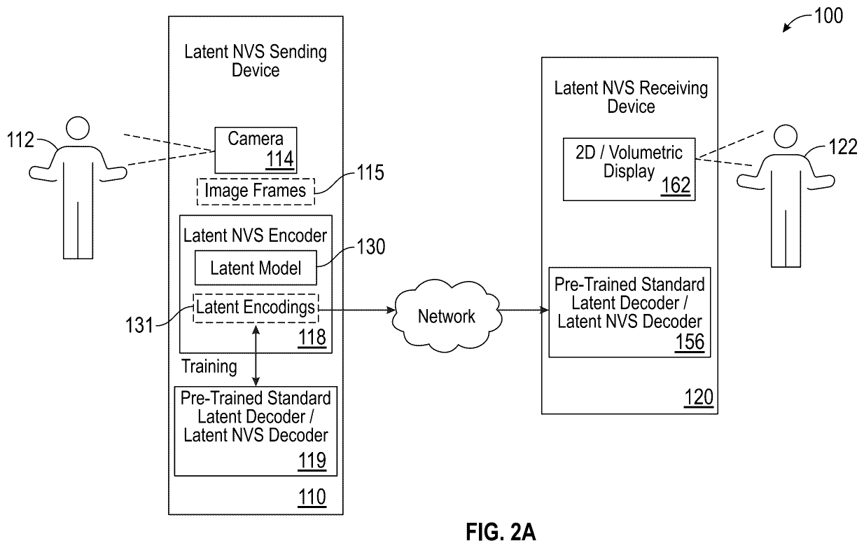

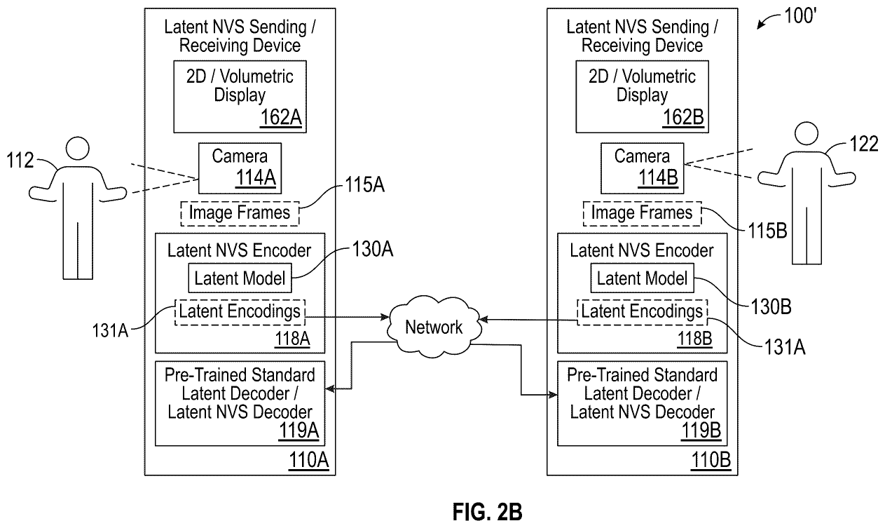

FIG. 2A illustrates a latent novel view synthesis (NVS) communication system 100 in accordance with an embodiment. The system 100 includes a latent NVS sending device 110 associated with a first user 112 and a latent NVS receiving device 120 associated with a second user 122. During operation of the system 100 a camera 114 within the latent NVS sending device 110 captures images 115 of an object or a static or dynamic scene. For example, the camera 114 may record a video including a sequence of image frames 115 of the object or scene. The first user 112 may or may not be appear within the image frames 115. A latent NVS encoder 118 is configured to generate, preferably in real time, a latent model 130 of the object or static/dynamic scene using the image frames 115. As is discussed below, the latent NVS encoder 118 performs a training operation in conjunction with a latent decoder 119 to train the latent model 130, which may be implemented using one or more artificial neural network(s) (ANN(s)). The training operation may include, for example, providing the image frames 115 to the latent NVS encoder 118 for use in generating latent encodings 131 representative of the latent model 130. To facilitate training the latent model in or near real-time, the ANN(s) corresponding to the latent model 130 are trained in a latent space of lower dimension than would otherwise be required using conventional techniques (e.g., NeRF). The latent encodings 131 are transferred to the latent decoder 119, which uses the latent encodings 131 to reconstruct imagery corresponding to the object or scene captured by the image frames 115. The latent model 130 is then adjusted based upon a comparison between the reconstructed imagery generated by the latent decoder 119 and the image frames 115.

When the latent decoder 119 is implemented as a latent NVS decoder in the form of an ANN, the latent decoder 119 may also be trained during this training process. In other embodiments the latent decoder 119 is implemented as a pre-trained standard decoder (e.g., a latent diffusion model decoder) and is not trained during the training process carried out by the latent sending device 110.

Once training of the latent model 130 based upon one or more image frames 115 has been completed, the latent encodings 131 are sent by the latent NVS sending device 110 over a network 150 to the latent NVS receiving device 120. When the latent decoder 119 is implemented as a latent NVS decoder in the form of one or more ANN(s), latent information defining the ANN(s) is also sent to the latent NVS receiving device 120. In either case a latent decoder 156 within the latent NVS receiving device 120 is configured to replicate the latent decoder 119 and reconstruct, in a two-dimensional or volumetric display 162, the object or scene captured by the image frames 115 using the latent encodings 131. In accordance with the disclosure, this reconstruction of the object or scene is “3D aware” in that the user of the device 120 may specify a virtual camera location and orientation corresponding to novel vies of the scene captured by the images 115.

FIG. 2B illustrates another latent novel view synthesis (NVS) communication system 1001 in accordance with an embodiment. As may be appreciated by comparing FIGS. 2A and 2B, the communication system 100′ is substantially similar to the communication system 100 of FIG. 2A with the exception that the first user 112 is associated with a first latent NVS sending/receiving device 110′ and the second user 122′ is associated with a second latent NVS/sending receiving device 120′. In the embodiment of FIG. 2B both the first latent NVS sending/receiving device 110′ and the second latent NVS/sending receiving device 120′ can generate latent encodings representative of an object or scene, sending such encodings to one or more other devices, and reconstructing novel views of other objects or scenes using latent encoding from such other devices. For example, the first user 112 and the second user 122 could use their respective devices latent NVS sending/receiving devices 110A, 110B to engage in a communication session during which each user 112, 122 could, preferably in real time, view and communicate with the other user 112, 122 in a 3D aware manner. That is, each user 112, 122 could view a scene captured the device 110A, 110B of the other user from a novel virtual camera location and orientation, preferably in real time. In embodiments in which the displays 162 of the devices 110 are implemented as volumetric displays configured to display the captured objects or scene volumetrically, such 3D aware communication effectively becomes a form of real-time or near real-time holographic communication.

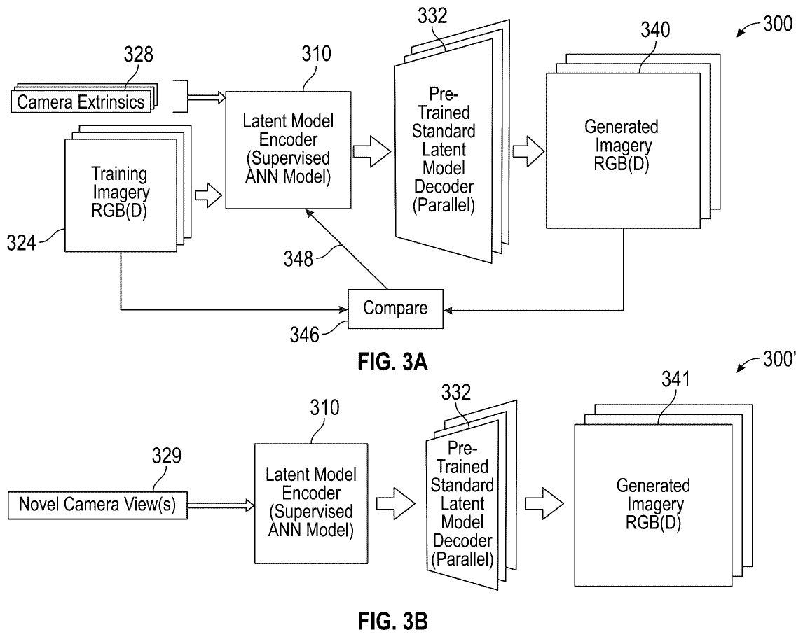

Attention is now directed to FIG. 3A, which illustrates a latent space novel view synthesis (NVS) process 300 for training an exemplary latent model encoder 310 to generate novel views of a scene using a supervised learning process in accordance with the disclosure. As shown, training images 324 (e.g., video frames) of a scene are provided along with associated camera extrinsics 328 (e.g., a camera location in the form of voxel coordinates (x,y,z) and a camera pose in the form of an azimuth and elevation) as input to the latent model encoder 310. The latent model encoder 310 may be implemented using a supervised artificial neural network (ANN). During training the latent model encoder 310 converts the training images 324 (e.g., frames of training videos) to latent space representations, which are typically compressed and typically not human interpretable. After these latent space representations undergo decoding by a latent model decoder 332 to generate RGB(D) imagery 340, this generated RGB(D) imagery 340 is compared 346 with the training imagery. Based upon this comparison the parameters of the ANN forming the latent model encoder 310 are adjusted 348 such that the generated imagery 340 reconstructs the training images 324. The presence of the latent model encoder 310 reduces the size of the ANN required to model the scene and obviates the need for a volume renderer, since the generated imagery 340 may be directly produced by the latent model decoder(s) 332. The latent model decoder 332 may include an upsampler to ensure final desired image resolution. The latent model decoder 332 may comprise multiple components (for example multiple stages of decoders).

FIG. 3B illustrates a process 300′ by which the latent model encoder 310 may be queried to render views of a scene in response to novel camera view(s) 329 of the scene provided by, for example, a user of a latent NVS receiving device. The process 300′ may be performed once the training process 300 has been completed and the latent space model corresponding to the latent model encoder 310 has been proved to the latent NVS receiving device. As the latent model encoder 310 may be customized for a specific application or adapted as the scenes to be transmitted change, the encoder 310 may be provided to the receiving device from the transmitting device prior to initial scene reconstruction in the receiving device and/or intermittently. In response to the latent model encoder 310 being queried with the one or more novel camera view(s) 329, the latent model decoder 332 is caused to directly generate RGB(D) imagery 341 corresponding to such view(s) 329. It may be appreciated that such direct rendering of the RGB(D) imagery 341 by the latent model decoder 332 is substantially less computationally intensive an operation than the conventional volume rendering process utilized in conventional NeRF-based systems. Even use of an efficient computer graphics engine would require export from the NeRF representation to a 3D mesh model, which is also computationally expensive and often uses the same volume renderer to produce those 3D models.

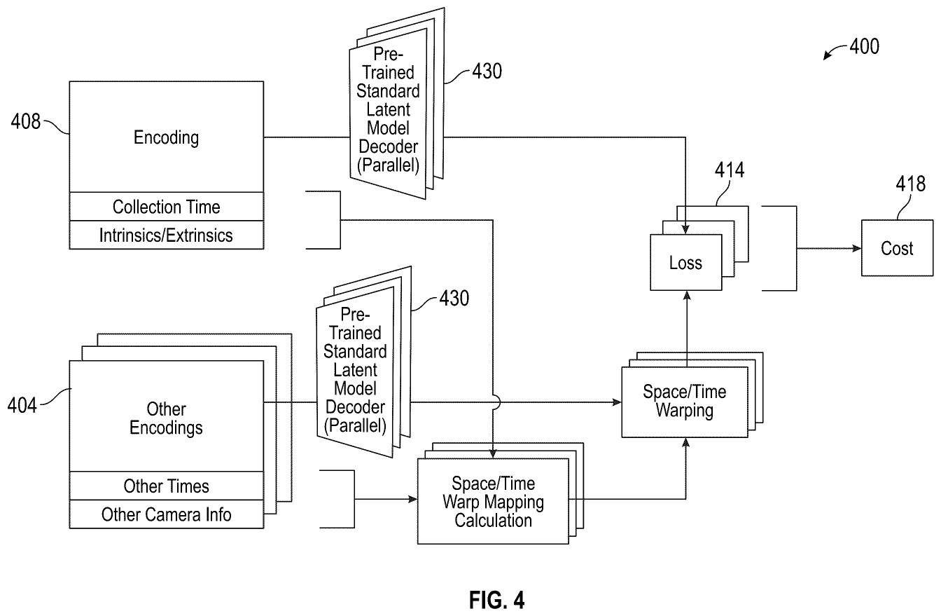

Turning now to FIG. 4, an exemplary view warping process 400 for improving depth accuracy is illustrated. In general, the method involves warping encodings 404 generated by the latent model encoder 110 of images (views) of a scene collected at times and viewing angles “nearby” the time of collection of a target image (view) corresponding to a target encoding 408 generated by the encoder 110. The space/time information from the nearby views corresponding to the encodings 408 may be used to compute the warping. The nearby images (and optionally) the target view may be synthetic views. Each image provides a loss 414 that is related to the geometric differences. The overall cost 418 is a combination of all the individual losses 414. A latent model decider 430 corresponding to a latent model with depth (e.g., a latent diffusion model with depth) may be utilized in the warping process 400.

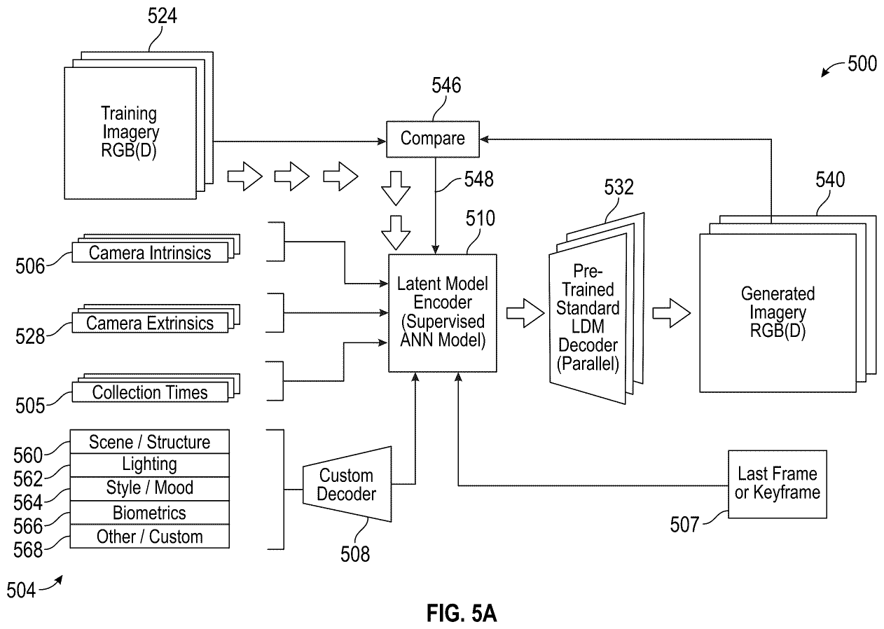

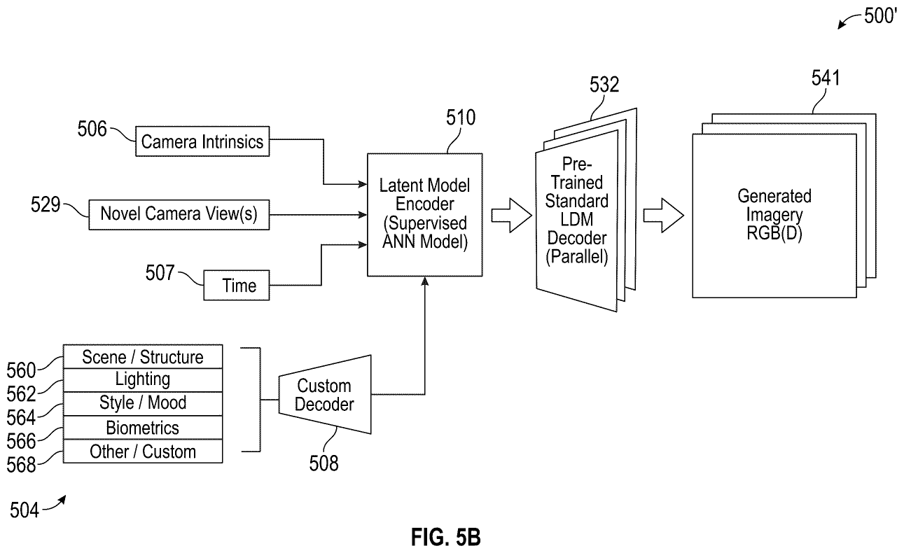

Attention is now directed to FIG. 5A, which illustrates a latent space NVS process 500 for training an exemplary latent model encoder 510 to synthesize novel views of a scene using a supervised learning with additional parametrization in accordance with the disclosure. Relative to the exemplary process 300 of FIG. 3A, the process 500 adds use of prior learned information 504 and camera intrinsics 506 (sensor information), which should allow for additional creative control including personalization and stylization. Additionally, the process 500 utilizes information from previous frame(s) 507 (e.g., from an immediately preceding frame or keyframe) during the training process in order to reduce model complexity and/or speed training time. The prior learned information 504 associated with the training images 324 (e.g., video frames) may include, for example, information relating to scene/structure 560, lighting 562, style/mood 564, biometrics 566 or other/custom information 568. In addition to explicit use of prior information, the supervised ANN model 510 may be initialized with the solution of that model from previous frames, a process that further improves training time when the previous frame has small differences and thus should have a similar latent representation.

As shown in FIG. 5A, training images 524 (e.g., video frames) of a scene are provided to a latent model encoder 510 along with associated camera extrinsics 528 (e.g., a camera location in the form of voxel coordinates (x,y,z) and a camera pose in the form of an azimuth and elevation), the camera intrinsics 506, and the previous frame information 507. In one embodiment the collections times 505 at which the images 524 are collected are also provided to the encoder 510, which may facilitate introducing basic motion into novel views of the scene being captured by the training imagery 524. The prior information 504 is provided to a custom decoder 508, which provides a decoded output to effect pre-training of the latent model encoder 510. The latent model encoder 510 may be implemented using a supervised artificial neural network (ANN). During training the latent model encoder 510 converts the training images 524 (e.g., frames of training videos) to latent space representations, which are typically compressed and typically not human interpretable. After these latent space representations undergo decoding by a latent model decoder 532 to generate RGB(D) imagery 540, this generated RGB(D) imagery 540 is compared 546 with the training imagery. Based upon this comparison the parameters of the ANN forming the latent model encoder 510 are adjusted 548 such that such that the generated imagery 540 reconstructs the training images 524. The presence of the latent model encoder 510 reduces the size of the ANN required to model the scene and obviates the need for a volume renderer, since the generated imagery 540 may be directly produced by the latent model decoder 532. The latent model decoder 532 may include an upsampler to ensure final desired image resolution.

FIG. 5B illustrates a process 500′ by which the latent model encoder 510 may be queried to render views of a scene in response to novel camera view(s) 529 of the scene provided by, for example, a user of a latent NVS receiving device. The process 500′ may be performed once the training process 500 has been completed and the latent space model corresponding to the latent model encoder 510 has been provided to the latent NVS receiving device. As the latent model encoder 510 may be customized for a specific application or adapted as the scenes to be transmitted change, the encoder 510 may be provided to the receiving device from the transmitting device prior to initial scene reconstruction in the receiving device and/or intermittently. In response to the query specifying the novel camera view(s) 529, the encoder 510 produces an encoded output which is utilized by the latent model decoder 532 to directly generate RGB(D) imagery 541 corresponding to the specified novel view(s) of the scene. These generated RGB(D) imagery 541 corresponding to the novel view(s) 529 may be modified or otherwise customized by, for example, specifying one or more of camera intrinsics 506, scene/structure 560, lighting 562, style/mood 564, biometrics 566 or other/custom information 568. In addition, basic motion may be introduced into the generated RGB(D) imagery 541 by also specifying a particular time interval 507.

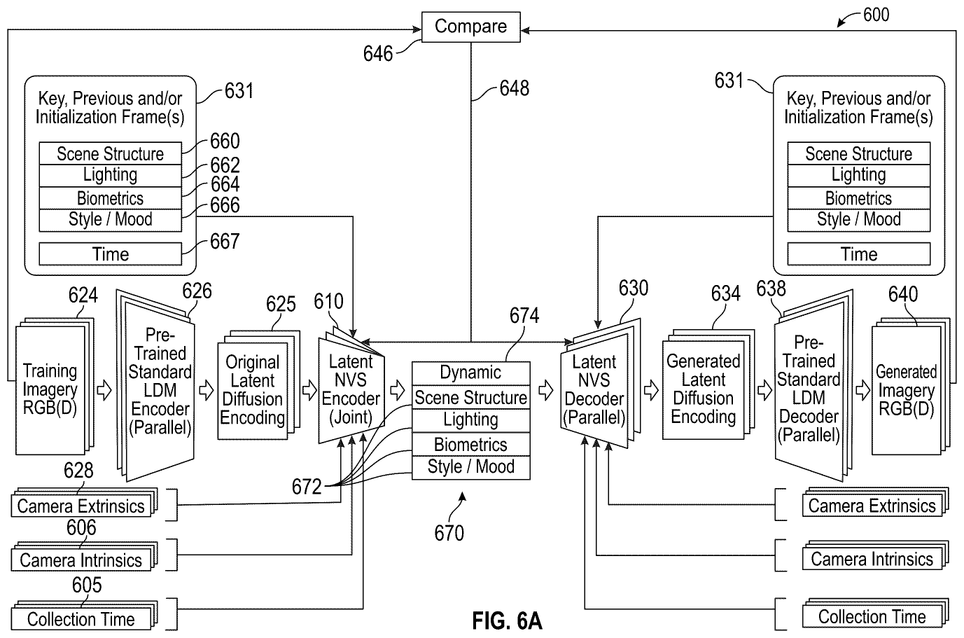

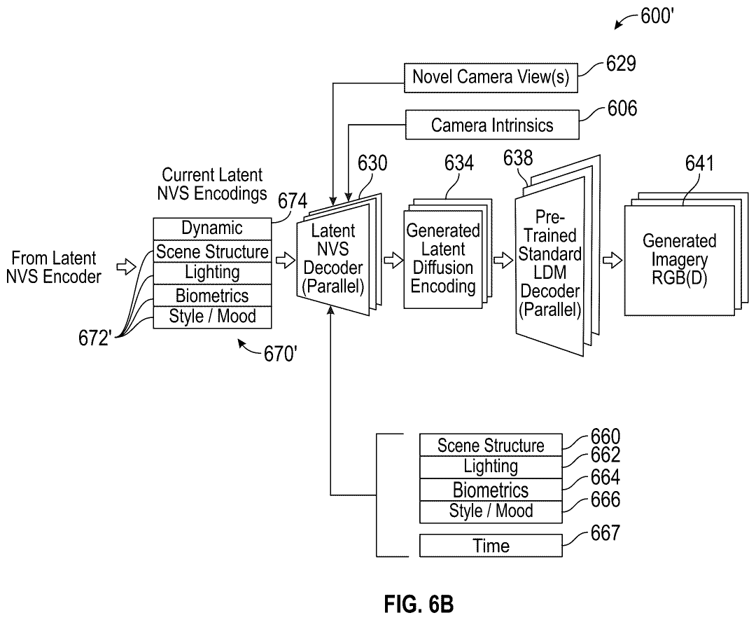

FIG. 6A illustrates a process 600 for training a joint latent NVS autoencoder to generate novel views of a scene without supervision. As may be appreciated from FIG. 6A, the per-scene supervised learning approach described with reference to FIGS. 3A and SA is replaced within an unsupervised, parameterized joint autoencoding process 600. A joint latent NVS encoder 610 uses a set of original latent space encodings 625 of training images 624 as input with associated parametrizing metadata (extrinsics 628, intrinsics 606, timing 605). The original latent space encodings 625 (e.g., latent diffusion encodings) of the training imagery 624 are generated by a pre-trained standard latent decoder 626 (e.g., a latent diffusion model encoder). Prior to initiating the training process using the training imagery 624, portions of the joint latent NVS encoder 610 and a latent NVS decoder 630 may each be pre-trained using prior latent neural encoding 631 associated with one or more prior image frames 631 (e.g., an immediately prior frame(s), a key frame, an initialization frame). The prior latent neural encoding 631 may, for example, include latent neural encoding relating to scene/structure 660, lighting 662, biometrics 564, style/mood 566 and time 667. As a result, a latent space encoder output 670 generated by the encoder 610 may include pre-trained latent neural encodings 672 corresponding to one or more of the latent neural encoding relating to scene/structure 660, lighting 662, biometrics 564, style/mood 566 and time 667, which may be identical to or an updated version of those input latent codes 631. The latent space encoder output 670 may further include dynamic latent neural encoding 674 associated with dynamic portions of the scenes represented by the training imagery 624. Such dynamic latent neural encoding 674 will generally correspond to aspects of the training imagery 624 differing from corresponding aspects of the prior frames (and not captured by the other encodings 660, 662, 664, 666) used in pre-training of the joint latent NVS encoder 610 and a latent NVS decoder 630 using the prior latent neural encoding 631.

As is indicated by FIG. 6A, during the training process the latent model encoder 610 jointly encodes the original latent space encodings 625 of multiple training images 624 into the latent space encoder output 670, which is typically compressed and typically not human interpretable. The latent space encoder output 670 decoded by the latent NVS decoder 630 into decoder-generated latent space encodings 634. These decoder-generated latent space encodings 634 are in turn decoded by a latent model decoder 638 to generate RGB(D) imagery 640, which is compared 646 with the training imagery. Based upon this comparison the parameters of the ANN forming the latent NVS encoder 610 and the latent NVS decoder 630 are adjusted 648 during the training process such that the (1) the latent space is “small” and (2) the generated imagery 640 is as “close” as possible to the training images 624. When an updated version of prior information 631 is also output by the decoder 630 based on the specific scene it may be seen as a Bayesian posterior estimate.

While in the embodiment of FIG. 6A the encoder 610 jointly uses the latent encodings of one or more input training images 624, the decoder 630 can be parallelized for each rendered view. In various exemplary embodiments a variable number of input images 624 would be jointly encoded by the encoder 610. It may be appreciated that in the embodiment of FIG. 6A the joint latent NVS encoder 610 and the parallel latent NVS decoder 630 form a joint auto-encoder that is capable of jointly encoding multiple images and functions to replace the supervised learning process described with reference to FIGS. 3 and 5. It may be further appreciated that the prior latent neural encoding 631 utilized in pre-training of the joint latent NVS encoder 610 and the parallel latent NVS decoder 630 will generally advantageously reduce overall training time.

FIG. 6B illustrates a process 600′ by which the latent NVS decoder 630 may be queried to render views of a scene in response to novel camera view(s) 629 of the scene provided by, for example, a user of a latent NVS receiving device. The process 600′ may be performed once the training process 600 has been completed and current latent NVS encodings generated by the latent model encoder 610 within a latent NVS sending device have been communicated to the latent NVS receiving device. As both the encoder 610 and the decoder 630 are generated during training, the decoder 630 is provided to the receiving device prior to an image generation interval occurring upon completion of a training cycle. As the decoder 630 may be customized for a specific application or adapted as the scenes to be transmitted change, the decoder 630 may be provided to the receiving device from the transmitting device prior to and/or intermittently. In response to the query specifying the novel camera view(s) 629, the latent NVS decoder 630 produces decoder-generated latent space encodings 634 corresponding to the specified novel view(s) 629 of the scene. These decoder-generated latent space encodings 634 are in turn decoded by the latent model decoder 638 to generate RGB(D) imagery 641. The generated RGB(D) imagery 641 corresponding to the novel camera view(s) 629 may be modified or otherwise customized by, for example, specifying one or more of camera intrinsics 606, scene/structure 660, lighting 662, style/mood 666, and/or biometrics 554. In addition, basic motion may be introduced into the generated RGB(D) imagery 641 by also specifying a particular time interval 667.

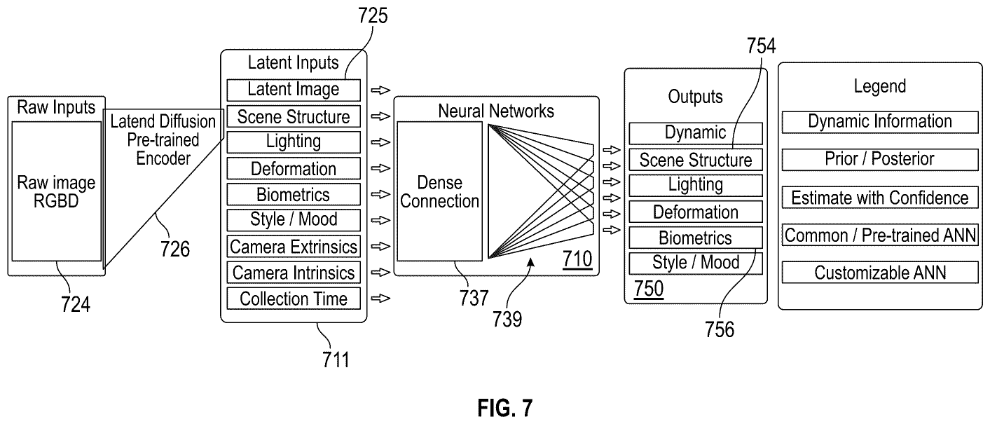

FIG. 7 provides a conceptual representation of the operation of the joint latent NVS autoencoder of FIG. 6A. As may be appreciated from FIG. 7, the inventive joint latent NVS autoencoder is preferably configured to facilitate customization and use of various prior/posterior information. Although only a single input image 724 is shown for clarity of presentation, it should be understood from FIG. 6A that one or more such input images may be jointly encoded by the joint latent NVS autoencoder.

As is illustrated by FIG. 7, a latent image 725 generated from the input image 724 by a pre-trained latent encoder 726 is provided to a latent NVS encoder 710. The latent image 725 is included among various latent inputs 711 also provided to the latent NVS encoder 710. In one embodiment the latent NVS encoder 710 is comprised of a common/pre-trained ANN 737 and a customizable ANN 739. Implementing at least a portion of the latent NVS encoder 710 as the customizable ANN 739 permits pre-transmission of customizable portions of the encoder 710 to a latent NVS receiving device. That is, in certain embodiments at least part of the latent encodings 750 output by the latent NVS encoder 710 may be transmitted to a latent NVS receiving device prior to completion of training of the encoder 710 with respect to the input image 724. For example, scene structure latent encodings 754 corresponding to a static room and biometric latent encodings 756 may be pre-transmitted by the latent NVS encoder 710.

The joint latent autoencoder of FIG. 7 further enables customization by jointly training a subset of embeddings. For example, the autoencoder may jointly train based upon the same scene but with different lighting or may jointly train based upon the same person in different scenes.

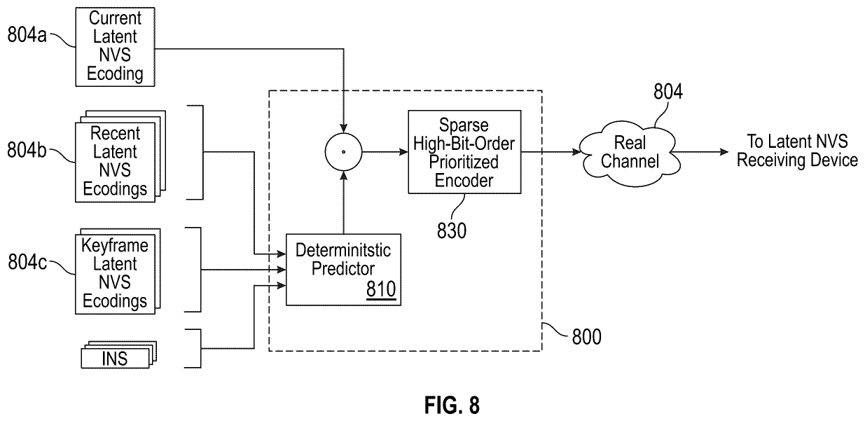

FIG. 8 is a functional view of a differential transmission encoder 800 designed to be included within a latent NVS sending device. The differential transmission encoder 800 is configured to selectively transmit latent encodings 804 generated by a latent NVS encoder over a communication channel 804 to a latent NVS receiving device. The differential transmission encoder 800 effects the transmission of differences from predictions 810 based on the encodings 804 for one or more previous frames (optionally key frames). In one embodiment the differential transmission encoder 800 includes a prioritized encoder 830 that promotes sparsity on the encoded coefficients, reducing the data required on a frame with little change. By prioritizing the more significant bits of the encoded differences, it is possible to improve perceptual quality over slow or lossy channels. In summary, in an exemplary embodiment the differential transmission encoder 800 is configured to send differences from previous (or key) frames and send more significant bits with higher priority.

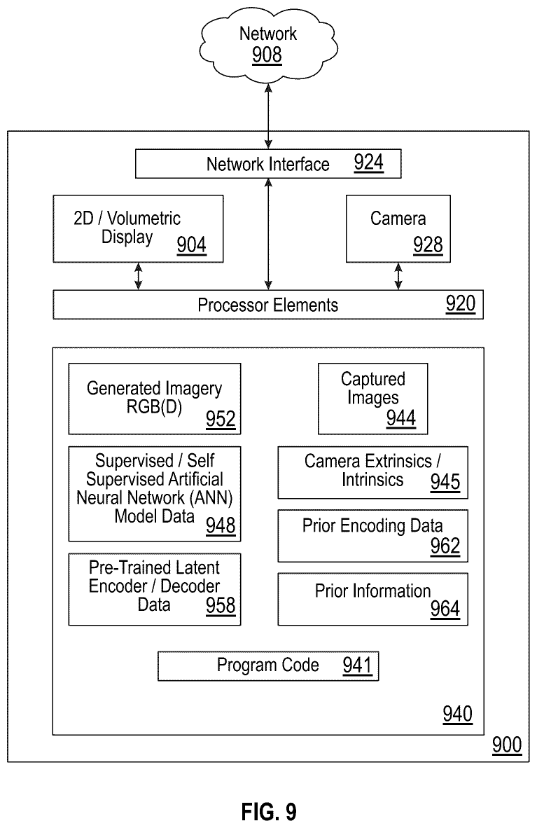

Attention is now directed to FIG. 9, which includes a block diagram representation of an electronic device 900 configured to operation as a latent NVS sending and/or latent NVS receiving device in accordance with the disclosure. It will be apparent that certain details and features of the device 900 have been omitted for clarity, however, in various implementations, various additional features of an electronic tablet as are known will be included. The device 900 may be in communication with another latent NVS sending and receiving device (not shown) via a communications link which may include, for example, the Internet, the wireless network 908 and/or other wired or wireless networks. The device 900 includes one or more processor elements 920 which may include, for example, one or more central processing units (CPUs), graphics processing units (GPUs), neural processing units (NPUs), neural network accelerators (NNAs), application specific integrated circuits (ASICs), and/or digital signal processors (DSPs). As shown, the processor elements 920 are operatively coupled to a touch-sensitive 2D/volumetric display 904 configured to present a user interface 208. The touch-sensitive display 904 may comprise a conventional two-dimensional (2D) touch-sensitive electronic display (e.g., a touch-sensitive LCD display). Alternatively, the touch-sensitive display 904 may be implemented using a touch-sensitive volumetric display configured to render information holographically. See, e.g., U.S. Patent Pub. No. 20220404536 and U.S. Patent Pub. No. 20220078271. The device 900 may also include a network interface 924, one or more cameras 928, and a memory 940 comprised of one or more of, for example, random access memory (RAM), read-only memory (ROM), flash memory and/or any other media enabling the processor elements 920 to store and retrieve data. The memory 940 stores program code 940 and/or instructions executable by the processor elements 920 for implementing the computer-implemented methods described herein.

The memory 940 is also configured to store captured images 944 of a scene which may comprise, for example, video data or a sequence of image frames captured by the one or more cameras 928. Camera extrinsics/intrinsics 945 associated with the location and pose and other details of the camera 928 used to acquire each image within the captured images 944 is also stored. The memory 940 may also contain neural network information 948 defining one or more neural network models, including but not limited to one or more encoder-decoder networks for implementing the methods described herein. The neural network information 948 will generally include neural network model data sufficient to train and utilize the neural network models incorporated within the latent NVS encoders and decoders described herein. The memory 940 may also store generated imagery 952 created during operation of the device as a latent NVS receiving device. As shown, the memory 940 may also store pre-trained latent encoder/decoder data 958, prior frame encoding data 962 (e.g., data defining a prior frame, initialization frame or key frame) and other prior information 964.

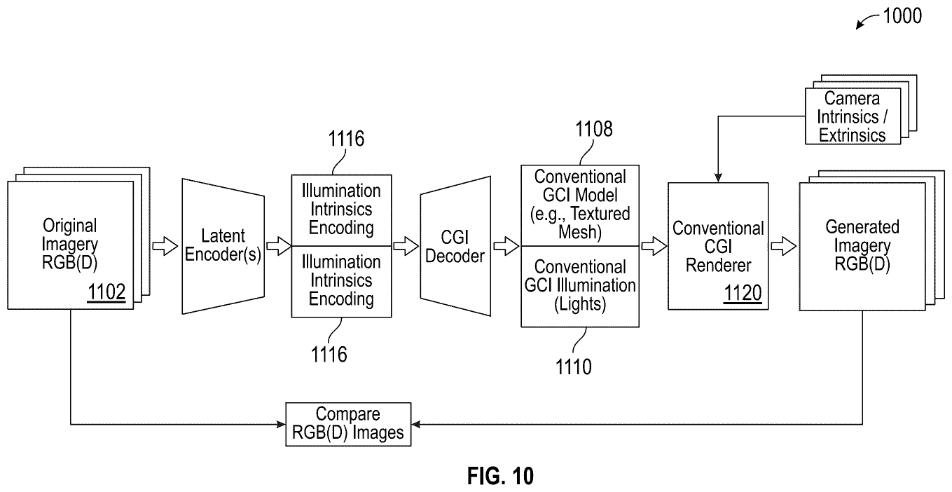

Turning now to FIG. 10, a block diagram is provided which illustrates a process 1000 for training a CGI variant of an auto-encoder in accordance with the disclosure. As shown, a latent representation of the original RGB(D) imagery 1102 could be decoded to an intermediate textured CGI format (e.g., textured mesh) that a conventional renderer (e.g., Unity or Unreal) could convert to an RGB(D) image viewable on a conventional or volumetric display. In this variation, part of the decoding procedure would involve a conventional CGI renderer 1120 (e.g., Unity, Unreal, etc.). That is, instead of using a single decoder that converts from latent space directly to images, the process 1000 contemplates first decoding to an intermediate CGI model (e.g., FBX format) which would include both the explicit model 1108 (e.g., a textured mesh) and explicit illumination 1110 (e.g., CGI Lights). In this implementation the illumination encoded intrinsics 1116 could include, for example, albedo, opacity, glossiness, transmissiveness, alpha map, and any other relevant data. The conventional GCI renderer 1120 can be optimized for the receiving device and may optionally be a commercial-off-the-shelf solution. By including both parts (the latent-to-CGI representation and the CGI renderer), it is possible to train this network in an unsupervised manner since the expectation is that the training will still cause the final rendered output to be as close as possible to the original input. In this case the fidelity could include geometric accuracy and/or other perceptual metrics. Of course, it will be appreciated that in other implementations supervised training could still be utilized.

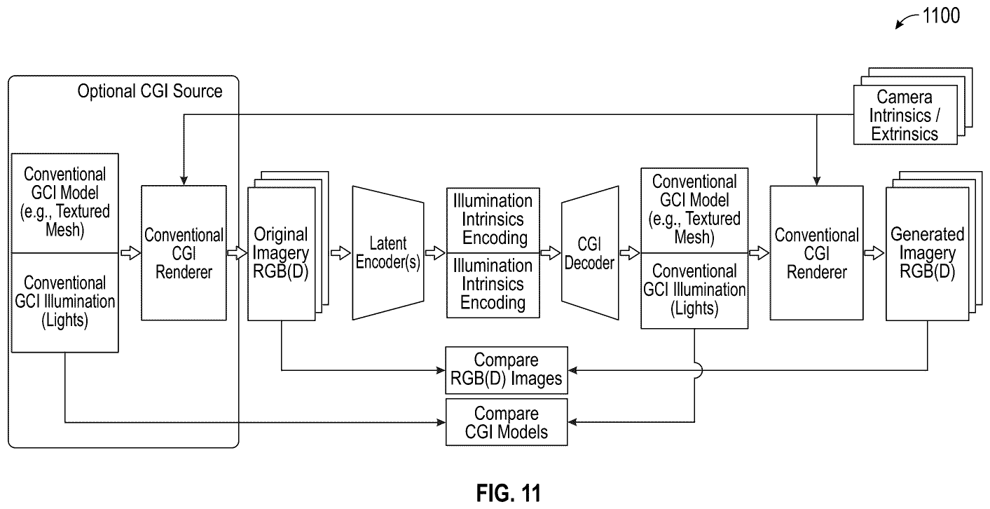

Attention is now directed to FIG. 11, which is a block diagram illustrating a process 1100 for training an alternate CGI variant of an auto-encoder in accordance with the disclosure. In another variation the input images could further be generated from a CGI Model. Training could be performed in this case either by comparing the CGI-rendered imagery or the original models or both.

Where methods described above indicate certain events occurring in certain order, the ordering of certain events may be modified. Additionally, certain of the events may be performed concurrently in a parallel process when possible, as well as performed sequentially as described above. Accordingly, the specification is intended to embrace all such modifications and variations of the disclosed embodiments that fall within the spirit and scope of the appended claims.

The foregoing description, for purposes of explanation, used specific nomenclature to provide a thorough understanding of the claimed systems and methods. However, it will be apparent to one skilled in the art that specific details are not required in order to practice the systems and methods described herein. Thus, the foregoing descriptions of specific embodiments of the described systems and methods are presented for purposes of illustration and description. They are not intended to be exhaustive or to limit the claims to the precise forms disclosed; obviously, many modifications and variations are possible in view of the above teachings. The embodiments were chosen and described in order to best explain the principles of the described systems and methods and their practical applications, they thereby enable others skilled in the art to best utilize the described systems and methods and various embodiments with various modifications as are suited to the particular use contemplated. It is intended that the following claims and their equivalents define the scope of the systems and methods described herein.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer implemented method comprising:
receiving one or more videos of a scene where each of the one or more videos is associated with camera extrinsics including a three-dimensional (3D) camera location and a camera direction;
training a neural network using the one or more videos and the camera extrinsics to encode frames of the one or more videos as a plurality of models of the scene in a latent space associated with a latent model decoder; and
transmitting one or more of the plurality of models of the scene to a viewing device including the latent model decoder;
wherein the latent model decoder is configured to decode the one or more of the plurality of models to generate imagery corresponding to novel 3D views of the scene.

2. A computer implement method comprising:
receiving a two-dimensional (2D) training image of a scene where the 2D training image is associated with a camera location and a camera direction;
providing the 2D training image, the camera location and the camera direction to a neural network;
encoding the 2D training image using a neural network to produce an initial latent space model of the scene;
decoding the initial latent space model of the scene using a pre-trained latent model decoder to produce initial generated imagery corresponding to the scene;
comparing the initial generated imagery to the 2D training image to evaluate an encoding loss based upon differences between the initial generated imagery to the 2D training image; and
updating weights of the neural network using a parameter of the encoding loss.
